(19) United States
(12) Patent Application Publication
(10) Pub. No.: US 2024/0102323 A1
(43) Pub. Date: Mar. 28, 2024

(54) MOTOR VEHICLE LOCK

(71) Applicant: KIEKERT AG, Heiligenhaus (DE)

(72) Inventor: Christian BARMSCHEIDT, Duisburg (DE)

(73) Assignee: KIEKERT AG, Heiligenhaus (DE)

(21) Appl. No.: 18/263,571

(22) PCT Filed: Jan. 14, 2022
(86) PCT No.: PCT/DE2022/100033

§ 371 Date: Jul. 31, 2023

(30) Foreign Application Priority Data
Feb. 10, 2021 (DE) 10 2021 103 094.3

(51) Int. Cl. E05B 77/34; E05B 85/02

(52) U.S. Cl. CPC E05B 77/34; E05B 85/02

(57) ABSTRACT

A motor vehicle lock, in particular a side door lock, comprising a locking mechanism having a rotary latch and at least one pawl, a plastic housing, a lock case, wherein an inlet region for a lock holder can be formed by means of the plastic housing and the lock case, and a seal, wherein the seal is allocated at least in regions to the inlet region and wherein the seal is made from a straight plastic strip.

The invention relates to a motor vehicle lock, in particular a side door lock, comprising a locking mechanism having a rotary latch and at least one pawl, a plastic housing, a lock case, wherein an inlet region for a lock holder can be formed by means of the plastic housing and the lock case, and a seal, wherein the seal is allocated at least in regions to the inlet region.

In daily use, motor vehicles are subject to weather and environmental conditions from which, on the one hand, the driver or the passenger must be protected and, on the other hand, the components of the motor vehicle must withstand the environmental influences. Rain, snow but also current influences and pressure differences must be compensated or kept as far as possible from the function of the components. In order to protect the passenger compartment from environmental influences, such as moisture, frost and unwanted air flow, the passenger compartment is sealed with a sealing profile between the driver door and the vehicle body, for example.

Various components of the motor vehicle door are, on the one hand, operatively connected to the external environment of the motor vehicle and, on the other hand, to the interior of the motor vehicle. Thus, for example, a motor vehicle lock installed in a side door of a motor vehicle is in the outer region in engagement with, for example, a lock holder, whereas another part of the motor vehicle lock can be operatively connected to an internal actuation, for example.

The motor vehicle lock is therefore, on the one hand, subject to the external environmental influences and, on the other hand, has to be located in the interior of the motor vehicle for connecting, for example, an internal actuation or an electrical contact in a drying region.

In order to seal a motor vehicle lock against environmental influences, such as moisture, a seal is known from DE 20 2008 004 332 U1, with which housing parts of the motor vehicle lock can be sealed. Motor vehicle lock housings are usually of two-part, three-part or multi-part design since, on the one hand, a proper and easy joining of the functional components must be made possible and, on the other hand, for example, manufacturing advantages are to be exploited. The disclosed seal comprises a U-shaped receiving chamber, into which a holding element is inserted, in such a way that a meander-shaped seal can be achieved, which can protect the lock housing from ingress of moisture.

Seals are arranged between the components of the housing for the motor vehicle lock, by means of which the housing protects the mechanical and electrical components of the motor vehicle lock. In this way, the components of the motor vehicle lock can be protected from ingress of moisture, which, for example, permeates through a pane seal into the interior of the motor vehicle door. In the region of the inlet mouth, i.e., in the region of the locking mechanism, which can be engaged with a latch holder, there is an opening in the motor vehicle lock through which the rotary latch of the locking mechanism can be engaged with the lock holder. Thus, an opening is present here through which environmental influences can act on the motor vehicle lock. In order to protect the motor vehicle lock and, in particular, the inlet region from ingress of moisture from the interior of the motor vehicle door, seals are applied to the motor vehicle lock. The motor vehicle lock is preferably formed from a plastic housing and a metal lock case. The plastic housing and lock case preferably circumferentially enclose the inlet region for the lock holder. Different solutions have become known as external seals applied to the motor vehicle lock.

For example, DE 10 2016 115 190 A1 discloses a motor vehicle lock with a lock case, wherein the lock case rests against the inner wall of the motor vehicle door in the region of the installation position and wherein a seal seals the motor vehicle lock against the wall of the motor vehicle door.

Furthermore, DE 10 2010 032 744 A1 discloses a method in which the lock housing is activated prior to the application of a sealing compound by means of a heat source and after which the sealing compound is subsequently applied as a seal to the lock housing or the lock case.

The solutions known from the prior art for sealing the motor vehicle lock against external environmental influences have proven themselves in principle. One problem which arises when applying or placing the seal onto the motor vehicle lock is that the seal must follow the contour of the motor vehicle lock or the side door, and that the seal must extend around the inlet mouth at a sharp angle, depending on the installation position. In order to be able to follow the contours and to enable optimal placement of the seal even at large angles, the seals are preferably punched out of large sealing pads. By punching out, an optimized application of the seal on the motor vehicle lock can be ensured. The disadvantage of this is that there can be a large amount of waste, which can have a negative impact on the cost of the motor vehicle lock. This is where the invention starts from.

The object of the invention is to provide an improved motor vehicle lock seal. In particular, the object of the invention is to minimize the high amount of material used for producing a seal and thus to ensure cost-effective sealing with consistent tightness, in particular in the region of large angulations or sharp contours.

The object is achieved by the features of independent claim 1. Advantageous embodiments of the invention are specified in the dependent claims. It should be noted that the embodiments described below are not limiting; rather, any possible variations of the features described in the description and the dependent claims are possible.

According to claim 1, the object of the invention is achieved by providing a motor vehicle lock, in particular a side door lock, comprising a locking mechanism having a rotary latch and at least one pawl, a plastic housing, a lock case, wherein an inlet region for a lock holder can be formed by means of the plastic housing and the lock case, and a seal, wherein the seal is allocated at least in regions to the inlet region and wherein the seal is made from a straight plastic strip material. Due to the design of the seal for the motor vehicle lock according to the invention, a seal for a motor vehicle lock can now be provided with the smallest possible material outlay. In particular, the use of a straight plastic strip offers the possibility of providing a seal for an inlet region of the motor vehicle lock with minimal waste. Sealing strips made from plastic can be separated from a plastic pad as strips, in such a way that waste can only result from a length limitation of the plastic strip. Preferably, the seal is formed from an elastomeric plastic material equipped with closed pores. In this case, the plastic strips can be available as roll material, which can result in further advantages, in particular for assembly.

If, according to the invention, reference is made to a motor vehicle lock, such locks are also included, which are used in flaps, sliding doors, side doors or covers, i.e. everywhere where environmental influences can act directly on the motor vehicle lock. As stated in the introduction, in particular in cases where movable pane elements are arranged in the door or flap system, moisture or dirt permeating through the pane seal must always be expected. The motor vehicle locks, which can also be referred to as locking systems, have a locking mechanism with a rotary latch and at least one pawl. The locking mechanism can have a pre-ratchet and a main ratchet and/or have an additional blocking lever for at least one pawl.

The components of the motor vehicle lock are mounted or accommodated in the housing and/or lock case of the motor vehicle lock. Thus, an outer surface of the motor vehicle lock is formed by the housing and the lock case. In many cases, the lock case encloses the inlet mouth or the inlet region for the latch holder, in such a way that ingress of moisture must be held off by means of the seal. Depending on the contour of the interior of the motor vehicle door, for example, the seal is applied to the lock case and/or the housing of the motor vehicle lock in such a way that sealing of the inlet region can be made possible. The seal is primarily arranged above the inlet region on the motor vehicle lock.

The plastic strip can advantageously be formed as a profiled plastic strip, preferably with a rectangular cross-section. Depending on the requirements in the motor vehicle lock, the plastic strip can, for example, be round, oval or quadrilateral and preferably rectangular in shape. In the case of an angular shape, the advantage is that the starting material can be in the form of a roll material, i.e., as a flat seal, from which plastic strips can then be separated. In this way, cost-effective manufacturing of the plastic strips can be realized. In particular, when the mat or roll from which the plastic strips are cut corresponds in width to the plastic strips to be manufactured.

If the plastic strip can be fastened to the lock case and/or plastic housing by means of an adhesive mask, a further advantageous embodiment variant of the invention results. A means by which the plastic strip can be fastened to the motor vehicle lock is described as an adhesive mask. Preferably, the adhesive mask consists of a carrier material to which an adhesive film is applied and to which the sealing material is bonded. If the plastic strip is now separated from the sealing material or the roll material and the adhesive mask, the carrier material, for example a paper strip, can be removed from the plastic strip, wherein the adhesive remains on the plastic strip. By means of the adhesive, the plastic strip can then be fastened to the motor vehicle lock, i.e., to the housing and the lock case. The use of a plastic mask is a preferred embodiment. However, it is also conceivable that, for example, an adhesive is applied to the motor vehicle lock and that the plastic strip is subsequently fastened to the motor vehicle lock.

It can also be advantageous and form an embodiment of the invention if the plastic strip has a width of 10 mm to 18 mm, preferably a width of 12 mm to 16 mm, and more preferably a width of 15 mm. The width of the plastic strip can vary depending on the application case, wherein a thickness of around 8-12 mm and preferably 10 mm has been found to be advantageous. The sealing strip must adapt or rest against the contour of the vehicle body and ensure tightness. The contour of the motor vehicle lock cannot always follow the contour of the motor vehicle door, so the gap to be sealed between the motor vehicle lock and the vehicle body can vary depending on the installation position. It has been shown that a sufficient gap sealing can be achieved with a width of 10-18 mm, and preferably 15 mm. In particular, the preferred width of the plastic strip can be used to securely seal a gap between the motor vehicle lock and the vehicle body.

It can also be advantageous and form an embodiment of the invention if the plastic strip is arranged at least in regions circumferentially, thus at least one angulation, on the lock case and/or lock housing. The plastic strip or sealing strip must securely seal the inlet region of the motor vehicle lock against ingress of moisture. In many cases, this leads to the plastic strip not extending linearly, but also angularly along the motor vehicle lock, in order to thus circumferentially enclose the inlet region at least in regions. Enclosing must take place in such a way that, in particular, the moisture permeating through, for example, a pane seal cannot enter the inlet region directly due to gravity, but is sealed by the sealing strip. Advantageously, the adhesive strip or the sealing strip can also selectively dissipate or discharge the moisture. Thus, the sealing strip is preferably arranged above an inlet region of the motor vehicle lock.

If the plastic strip has a notch in a region of the angulation, this results in an advantageous embodiment variant of the invention. In particular in the regions in which the plastic strip is angled to a planar surface of the motor vehicle lock, an accumulation of material occurs in the region of the angulation or the bend. The wider the plastic strip, the greater the accumulation of material in the region of the angulation. By introducing a notch into the region of the angulation, this accumulation of material can be reduced and optimally adjusted to the angulation. Thus, optimum tightness can also be ensured in the region of the angulation of the plastic strip without accumulations of material, for example, making assembly more difficult. In particular, an accumulation of material in the region of the angulation can also cause the plastic strip to detach from the motor vehicle lock, as a result of which a tight mounting is made more difficult or completely prevented. By making a notch in the plastic strip and, in particular, by introducing the notch in the region of the angulation, an accumulation of material can be prevented and a secure mounting of the adhesive strip on the motor vehicle lock can be guaranteed.

If the notch extends up to a region in the center of the plastic strip, a further advantageous embodiment of the invention is achieved. With a width of 14 mm, for example, the notch thus extends approximately 7 mm into the sealing strip. By means of a remaining region of likewise 7 mm, sufficient tightness can also be ensured in the region of the angulation of the plastic strip. In this case, the notch extends over the entire thickness of the plastic strip, in such a way that an angling of the plastic strip is not hindered by additional material in the angled region.

The notch may have a preferred opening angle of 70° to 110°, preferably an opening angle of 80° to 100°, and more preferably an opening angle of 90°. The angles mentioned have been found to be advantageous since, on the one hand, an angling of the plastic strip without an accumulation of material in the region of the angle can be achieved and, additionally, a sufficient tightness in the region of the angulation can be achieved. Here, the opening angle makes it possible to realize an angulation of the plastic strip of, for example, 30° or 40°, but it is also conceivable to realize, for example, an angulation of 90° in the plastic strip, without an accumulation of the sealing material causing the plastic strip to detach from the motor vehicle lock. Although the accumulation of material is present in the remaining region of the notch, it has been shown that the reduced accumulation of the material in the angled region allows the plastic strip to be securely mounted to the motor vehicle lock. Even an angulation of more than 90° can be realized with the plastic strip according to the invention if, for example, the opening angle is adapted to the angulation. Thus, a secure sealing of the inlet region of the motor vehicle lock can be realized with the least possible waste of the sealing material.

Furthermore, it has been shown that a further advantageous embodiment variant can be achieved if there is a flattening of 1 mm to 5 mm, preferably 2.5 to 3.5 mm, and even more preferably 3 mm, in a notch base. In this embodiment, the notch is formed by an exemplary opening angle of 90°, wherein a notch base in the plastic strip may have a flattening of 3 mm, for example. The flattening in the notch base of the sealing strip makes it possible to achieve a stabilization of the plastic strip, which in turn leads to increased tightness in the angled region of the plastic strip. Thus, a secure sealing of the motor vehicle lock can be realized and ensured with minimal material outlay.

The invention is explained in more detail below with reference to the accompanying drawings on the basis of a preferred embodiment. However, the principle applies that the embodiment does not limit the invention, but is merely an advantageous embodiment. The features shown can be implemented individually or in combination with further features of the description as well as the claims—individually or in combination.

In the figures:

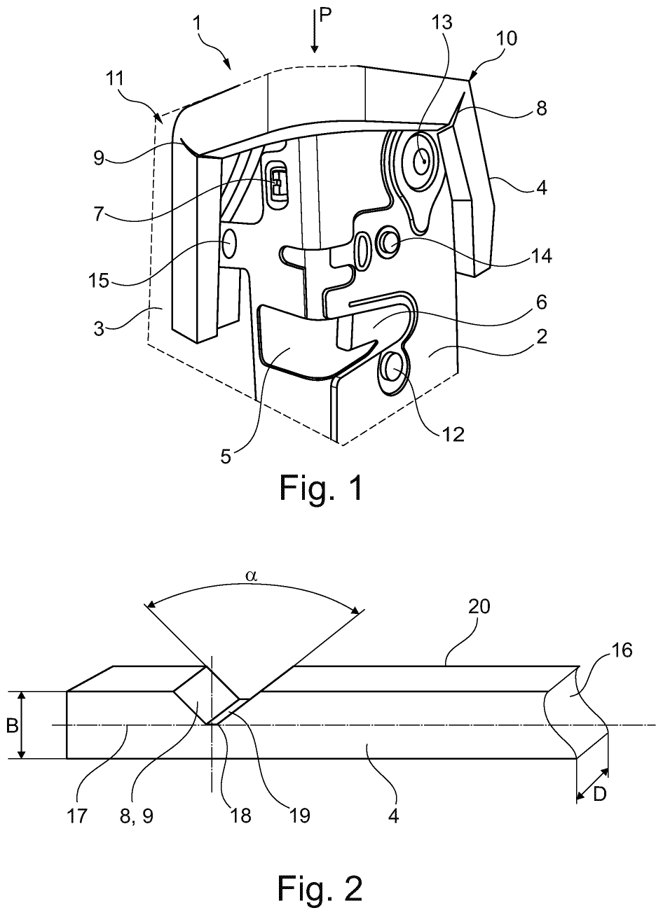

FIG. 1 shows a three-dimensional view of a motor vehicle lock having a plastic strip attached according to the invention in a three-dimensional view of the plastic strip; and

FIG. 2 shows a three-dimensional view of a partial region of the plastic strip in the initial state with a punched notch and a flattening formed in the notch base.

FIG. 1 shows a motor vehicle lock 1 in a three-dimensional view and detached from a motor vehicle. Consequently, the motor vehicle lock 1 is shown in a position as it is prior to assembly in the motor vehicle. The motor vehicle lock 1 comprises a lock case 2, a lock housing 3, a plastic strip 4 and an inlet region 5. In the inlet region 5, a part of a locking mechanism and, in particular, a rotary latch 6 can be seen. In this exemplary embodiment, the lock case 2 fully encloses the inlet region 5, wherein the lock case 2 is connected to the lock housing by a clip connection 7.

The plastic strip 4 is bonded to the lock case 2 and the lock housing 3 as a sealing strip. In this case, the plastic strip 4 encloses the inlet region 5 at least in regions and, in particular, the plastic strip 4 protects the inlet region 5 from ingress of moisture, which, for example, acts on the motor vehicle lock 1 starting from a pane seal from the direction of the arrow P. The plastic strip 4 is mounted circumferentially on the motor vehicle lock 1 in regions, wherein the plastic strip 4 is provided with two notches 8, 9.

In this case, the notches 8, 9 allow the plastic strip 4 to be mounted on the motor vehicle lock 1 in a sealing manner even in regions of angulations 10, 11. In particular, a secure joining of the plastic strip 4 on the motor vehicle lock 1 can be ensured without the plastic strip 4 attaching to the motor vehicle lock 1 under increased material tensions. By inserting the notch 8, 9 into the plastic strip 4, it is possible in this case for an accumulation of material in the region of the angulations 10, 11 to form and, for example, to hinder assembly or make assembly more difficult. The risk of the plastic strip 4 detaching from the motor vehicle lock on its own is also minimized, since stresses in the interior of the plastic strip 4 are reduced or eliminated by the notch 8, 9.

In the region of the lock case 2, rivet heads 12, 13, 14, 15 can be seen, by means of which either a connection is established to the lock housing 3 or with which other components of the motor vehicle lock 1 are mounted and/or held. For example, the rivet heads 12, 14 can be provided for mounting locking mechanisms parts 6 in the motor vehicle lock 1.

The locking mechanism 6 engages with a lock holder, which is not shown, through the inlet region 5.

FIG. 2 shows a partial region of a seal 4 as a plastic strip 4 in a principal embodiment. Shown is a partial region of the plastic strip 4, in the region of a notch 8, 9, wherein the plastic strip 4 has a cross-sectional area 16, which can be described as rectangular. The cross-sectional area 16 is shown as a section through the plastic strip 4.

The notch 8, 9 in the plastic strip 4 extends up to a midline 17 of the plastic strip 4 and extends across the entire thickness D of the plastic strip 4. In this exemplary embodiment, the notch 8, 9 has an opening angle α of 90°. In the notch base 18, a flattening 19 can be seen, which also extends across the entire thickness of the plastic strip 4. In the exemplary embodiment, the width B of the plastic strip 4 is referenced, whereby the width can be 15 mm, for example.

By introducing the notch 8, 9 in the plastic strip 4, it is possible to connect the plastic strip 4 to the motor vehicle lock 1 via a mounting surface 20, which in FIG. 2 forms a rear side of the plastic strip 4 that can be seen. Of course, the side of the plastic strip 4 facing the viewer can also form the adhesive surface for the plastic strip 4. By introducing the notch 8, 9 into the plastic strip 4, a plastic strip with the least possible amount of waste from, for example, a roll material can be manufactured as a seal, resulting in cost-effective manufacturing for the plastic strip 4 as a seal for the motor vehicle lock 1.

### LIST OF REFERENCE SIGNS

1 Motor Vehicle Lock
2 Lock case
3 Lock housing
4 Plastic strip
5 Inlet region
6 Rotary latch
7 Clip connection
8, 9 Notch
10, 11 Angulation
12, 13, 14, 15 Rivet head
16 Cross-sectional area
17 Midline
18 Notch base
19 Flattening
20 Mounting surface
P Arrow
D Thickness
α Opening angle
B Width

1. A motor vehicle lock comprising:
a locking mechanism having a rotary latch and at least one pawl,
a plastic housing,
a lock case, wherein an inlet region for a lock holder is formed by the plastic housing and the lock case, and
a seal, wherein the seal is allocated at least in an area of the inlet region to seal the inlet region, and wherein the seal is made from a straight plastic strip.

2. The motor vehicle lock according to claim 1, wherein the plastic strip is formed as a profiled plastic strip with a rectangular cross-section.

3. The motor vehicle lock according to claim 1, wherein the plastic strip is attached to the lock case and/or lock housing by an adhesive mask that includes a carrier material to which a sealing material is bonded.

4. The motor vehicle lock according to claim 1, wherein the plastic strip has a width of 10 mm to 18 mm.

5. The motor vehicle lock according to claim 1, wherein the plastic strip is arranged circumferentially, at least in regions, with at least one angulation on the lock case and/or on the lock housing.

6. The motor vehicle lock according to claim 5, wherein the plastic strip has a notch in a region of the angulation.

7. The motor vehicle lock according to claim 6, wherein the notch extends into a region in a center of the plastic strip.

8. The motor vehicle lock according to claim 6, wherein the notch has an opening angle of 70° to 110°.

9. The motor vehicle lock according to claim 1, wherein the plastic strip has a notch extending across an entire thickness of the plastic strip.

10. The motor vehicle lock according to claim 9, wherein, in a notch base of the notch, there is a flattening of 1 mm to 5 mm, preferably 2.5 mm to 3.5 mm, and more preferably a flattening of 3 mm.

11. The motor vehicle lock according to claim 1, wherein the plastic strip has a width of 10 mm to 16 mm.

12. The motor vehicle lock according to claim 1, wherein the plastic strip has a width of 15 mm.

13. The motor vehicle lock according to claim 6, wherein the notch has an opening angle of 80° to 100°.

14. The motor vehicle lock according to claim 6, wherein the notch has an opening angle of 90°.

15. The motor vehicle lock according to claim 9, wherein, in a notch base of the notch, there is a flattening of 2.5 mm to 3.5 mm.

16. The motor vehicle lock according to claim 9, wherein, in a notch base of the notch, there is a flattening of mm.

17. The motor vehicle lock according to claim 9, wherein the seal is made of an elastomeric plastic with closed pores.
